(19) United States
(12) Patent Application Publication
(10) Pub. No.: US 2013/0197165 A1
(43) Pub. Date: Aug. 1, 2013

(54) METHOD OF PRODUCING LIQUID CRYSTAL POLYESTER

(71) Applicant: Sumitomo Chemical Company, Limited, Tokyo (JP)

(72) Inventors: Shinji OHTOMO, Tsukuba-shi (JP); Hidehiro KOTAKA, Tsukuba-shi (JP)

(73) Assignee: Sumitomo Chemical Company, Limited, Tokyo (JP)

(21) Appl. No.: 13/750,349

(22) Filed: Jan. 25, 2013

(30) Foreign Application Priority Data
Jan. 31, 2012 (JP) 2012-018941

(51) Int. Cl. C09K 19/38

(52) U.S. Cl. CPC C09K 19/38
USPC 525/450

(57) ABSTRACT

A method is provided of producing a liquid crystal polyester, including: preparing a liquid crystal polyester prepolymer containing a repeating unit represented by general formula (1) and a repeating unit represented by general formula (2) by melt polymerization, cooling and solidifying the prepolymer to obtain a solidified prepolymer, pulverizing the solidified prepolymer to obtain a prepolymer powder, and heating the prepolymer powder to conduct solid-phase polymerization. A liquid crystal polyester is thereby prepared having a polymerization degree higher than the prepolymer. Preparing a liquid crystal polyester is performed with a rate of temperature rise within a temperature range of from a temperature 10° C. lower than a final end-point temperature of the solid-phase polymerization to the final end-point temperature of from 0.01° C./min to 0.03° C./min.

### TECHNICAL FIELD

The present invention relates to a method of producing a liquid crystal polyester.

Priority is claimed on Japanese Patent Application No. 2012-018941, filed on Jan. 31, 2012, the content of which is incorporated herein by reference.

### BACKGROUND ART

Liquid crystal polyesters which exhibit liquid crystallinity upon melting have excellent heat resistance and processability, and are therefore used in various application fields.

A liquid crystal polyester is obtained by polycondensation of a corresponding monomer such as an aromatic hydroxycarboxylic acid or an ester compound. By increasing the molecular weight of the obtained liquid crystal polyester, the mechanical strength can be improved, and the liquid crystal polyester can be preferably used in various application fields. However, when the molecular weight is increased to a desired molecular weight, there is a problem that the obtained polymer has a high viscosity, such that it is difficult to discharge the polymer from the reaction vessel, and hence, continuous production is difficult.

In order to solve this problem, a polymerization method such as that disclosed in Patent Document 1 is known. In the method described in Patent Document 1, firstly, polycondensation is conducted by melt polymerization within a reaction vessel, and the polymer is collected in a molten state while it is possible to easily discharge the polymer from the reaction vessel, followed by solidifying the polymer. Then, the polymer is subjected to solid-phase polymerization to increase the molecular weight of the polymer to a desired molecular weight. In this manner, it becomes possible to realize increasing the molecular weight of the liquid crystal polyester and improving the productivity.

### DOCUMENTS OF RELATED ART

### Patent Document

[Patent Document 1] Japanese Unexamined Patent Application, First Publication No. 2001-72750

### SUMMARY OF THE INVENTION

Generally, in the above method, prior to the solid-phase polymerization, the liquid crystal polyester prepolymer obtained by the melt polymerization reaction is pulverized, and the obtained powder is heated so as to increase the molecular weight. However, there were cases where the powder particles after the solid-phase polymerization strongly adhere to each other (hereafter, such strong adhesion of the powder particles is sometimes referred to as “sintering”). When sintering occurs, the liquid crystal polyester cannot be obtained in the form of a powder, so that the liquid crystal polyester is unsuitable as a product. Further, for obtaining a liquid crystal polyester powder, it becomes necessary to perform the pulverizing step again, thereby deteriorating the productivity. Therefore, there were demands for a production method in which sintering of the resin powder after the solid-phase polymerization can be suppressed.

The present invention takes the above circumstances into consideration, with an object of providing a method of producing a liquid crystal polyester which can suppress sintering and enable a stable production.

For solving the above problems, the present invention provides a method of producing a liquid crystal polyester, including: preparing a liquid crystal polyester prepolymer containing a repeating unit represented by general formula (1) shown below and a repeating unit represented by general formula (2) shown below by melt polymerization, cooling and solidifying the prepolymer to obtain a solidified prepolymer, pulverizing the solidified prepolymer to obtain a prepolymer powder, and heating the prepolymer powder to conduct solid-phase polymerization, thereby preparing a liquid crystal polyester having a polymerization degree higher than the prepolymer, wherein preparing a liquid crystal polyester is performed with a rate of temperature rise within a temperature range of from a temperature 10° C. lower than a final end-point temperature of the solid-phase polymerization to the final end-point temperature of from 0.01° C./min to 0.03° C./min:

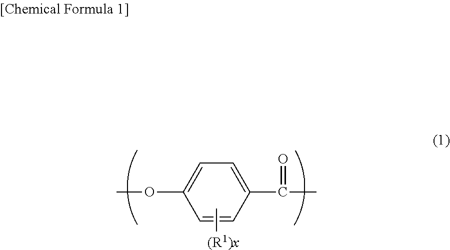

wherein R¹ represents a chlorine atom, a bromine atom or an alkyl group of 1 to 4 carbon atoms; and x represents an integer of 0 to 4, provided that, when x represents an integer of 2 or more, the plurality of R¹ may be the same or different from each other; and the repeating unit represented by general formula (1) may contain a plurality of repeating units in which at least one R¹ is different from other R¹; and

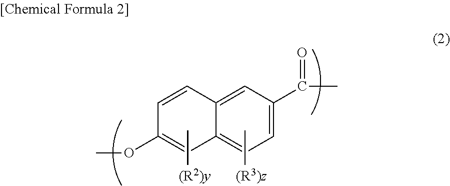

wherein R² and R³ each independently represent a chlorine atom, a bromine atom or an alkyl group of 1 to 4 carbon atoms; y represents an integer of 0 to 3; and z represents an integer of 0 to 3, provided that R² and R³ may be the same or different from each other, and the repeating unit represented by general formula (2) may contain a plurality of repeating units in which at least one of R² and R³ is different from other R² and R³.

In the present invention, it is preferable that the amount of the repeating unit represented by general formula (1) is from 20 mol % to 80 mol %, based on the total amount of all repeating units, and the amount of the repeating unit represented by general formula (2) is from 20 mol % to 80 mol %, based on the total amount of all repeating units.

In the present invention, it is preferable that the final end-point temperature is 200° C. to 255° C.

According to the method of producing a liquid crystal polyester of the present invention, sintering can be suppressed, and it becomes possible to stably produce a liquid crystal polyester in a continuous manner.

### MODE FOR CARRYING OUT THE INVENTION

The method of producing a liquid crystal polyester according to the present embodiment includes: preparing a liquid crystal polyester prepolymer containing a repeating unit represented by general formula (1) shown below and a repeating unit represented by general formula (2) shown below by melt polymerization, cooling and solidifying the prepolymer to obtain a solidified prepolymer, pulverizing the solidified prepolymer to obtain a prepolymer powder, and heating the prepolymer powder to conduct solid-phase polymerization, thereby preparing a liquid crystal polyester having a polymerization degree higher than the prepolymer, wherein preparing a liquid crystal polyester is performed with a rate of temperature rise within a temperature range of from a temperature 10° C. lower than a final end-point temperature of the solid-phase polymerization to the final end-point temperature of from 0.01° C./min to 0.03° C./min:

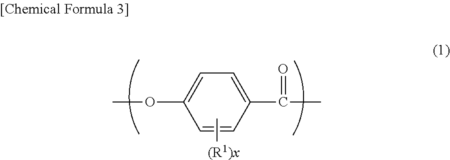

wherein R¹ represents a chlorine atom, a bromine atom or an alkyl group of 1 to 4 carbon atoms; and x represents an integer of 0 to 4, provided that, when x represents an integer of 2 or more, the plurality of R¹ may be the same or different from each other; and the repeating unit represented by general formula (1) may contain a plurality of repeating units in which at least one R¹ is different from other R¹; and

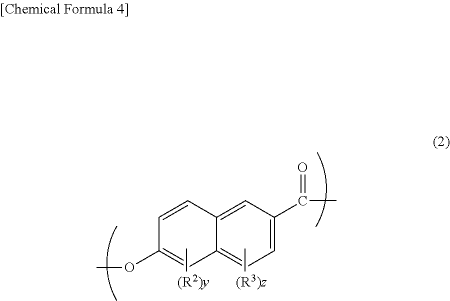

wherein R² and R³ each independently represent a chlorine atom, a bromine atom or an alkyl group of 1 to 4 carbon atoms; y represents an integer of 0 to 3; and z represents an integer of 0 to 3, provided that R² and R³ may be the same or different from each other, and the repeating unit represented by general formula (2) may contain a plurality of repeating units in which at least one of R² and R³ is different from other R² and R³.

Here, an “alkyl group of 1 to 4 carbon atom” refers to a group selected from the group consisting of a methyl group, an ethyl group, a propyl group (an n-propyl group), an isopropyl group, a butyl group (an n-butyl group), an isobutyl group, a sec-butyl group and a tert-butyl group.

Further, in general formula (2), R² is a substituent which may be bonded to the 5th position, the 7th position or the 8th position of the naphthylene group, and R³ is a substituent which may be bonded to the 1st position, the 3rd position or the 4th position of the naphthylene group.

The initial flow temperature is also called the flow temperature. The flow temperature is measured by melting a liquid crystal polyester under a load of 9.8 MPa (100 kg/cm²) while raising the temperature at a rate of 4° C./min, and the temperature at which the liquid crystal polyester exhibits a viscosity of 4,800 Pa·S (48,000 poise) as measured using a capillary rheometer when extruded from a nozzle having an inner diameter of 1 mm and a length of 10 mm is defined as the flow temperature. The flow temperature can be used as a yardstick for the molecular weight of a liquid crystal polyester (see “Liquid crystal polymer—synthesis, molding and application—” written by Naoyuki Koide, published by CMC Publishing CO., LTD, Jun. 5, 1987; see page 95).

In the description below, a polymer obtained by melt polymerizing a monomer is referred to as a “prepolymer”, and a polymer obtained by a solid-phase polymerization in which a prepolymer is subjected to a heat treatment in a solid-phase state to increase the molecular weight is referred to as an objective “liquid crystal polyester”.

Further, in the present invention, a “step of preparing a prepolymer” is referred to as “melt polymerization step”, a “step of obtaining a prepolymer powder” is referred to as “pulverizing step”, and a “step of preparing a liquid crystal polyester” is referred to as “solid-phase polymerization step”, and each step will be described below.

(Melt Polymerization Step)

In the melt polymerization step, a compound represented by general formula (I) shown below and a compound represented by general formula (II) shown below are subjected to a polycondensation reaction in a reaction vessel. At this time, these compounds may be fed to the reaction vessel in a mixed state, or these compounds may be separately fed to the reaction vessel.

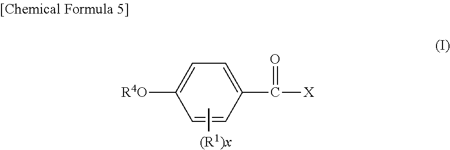

In the formula, R¹ and x are the same as defined in general formula (1); R⁴ represents a hydrogen atom, a formyl group, an acetyl group, a propionyl group or a benzoyl group; and X represents a hydroxyl group, an organyloxy group, a halogen atom or an acyloxy group; provided that the compound represented by general formula (I) may contain a plurality of compounds in which at least one of R¹, R⁴ and X is different.

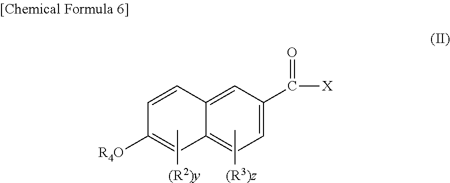

In the formula, R², R³, y and z are the same as defined in general formula (2); R⁴ and X are the same as defined in general formula (I), provided that R⁴ and X in general formulae (I) and (II) may be the same or different from each other; and the compound represented by general formula (II) may contain a plurality of compounds in which at least one of R², R³, R⁴ and X is different.

The polycondensation reaction in the present embodiment can be performed in an inert gas such as a nitrogen gas under normal pressure or reduced pressure. However, it is preferable to perform the polycondensation reaction in an inert gas under normal pressure. The process may be conducted in a batchwise manner, a continuous manner or a combination thereof.

With respect to the temperature in the polycondensation reaction in the present embodiment, the final end-point temperature of the melt polymerization is preferably in the range of 260° C. to 330° C., and more preferably 270° C. to 320° C. In the present invention, when the reaction vessel is divided or separated in a multistage, the highest reaction temperature is the final end-point temperature.

Although the polycondensation reaction would proceed without a catalyst, if desired, an oxide or an acetate salt of Ge, Sn, Ti, Sb, Co, Mn or the like can be used as a catalyst. For example, it is necessary to remove any catalyst component after the polymerization, depending on the application (e.g., food application). It is preferable to use no catalyst in the polymerization of a liquid crystal polyester for such application. Therefore, it is preferable to select whether or not to use a catalyst, depending on the application.

In the polycondensation reaction, with respect to the shape of the reaction vessel, any conventionally known reaction vessel can be used. With respect to the agitator, in the case of a vertical reaction vessel, a multistage paddle blade, a turbine blade, a monte blade and a double helical blade are preferable, and a multistage paddle blade, and a turbine blade are more preferable. In the case of a horizontal reaction vessel, a uniaxial or biaxial agitator having blades of various shapes, such as a lens blade, a glasses blade and a multi-circular plate blade, provided perpendicular to the agitator is preferable. Further, a blade twisted for improving the agitation performance and feeding mechanism is also preferable.

Heating of the reaction vessel is conducted by a heat medium, a gas or an electric heater. In terms of uniform heating, it is preferable to heat not only the reaction vessel but also members inside the reaction vessel which are immersed in the reaction product, such as an agitator, a blade and a baffle plate.

In the case where the monomer used in the polycondensation reaction contains a compound having a phenolic hydroxyl group, such as either or both of a compound represented by general formula (3) shown below and compound represented by general formula (4) shown below, it is preferable that the method of producing a liquid crystal polyester includes, prior to the melt polymerization step, a step of performing a reaction to increase the reactivity of the phenolic hydroxyl group.

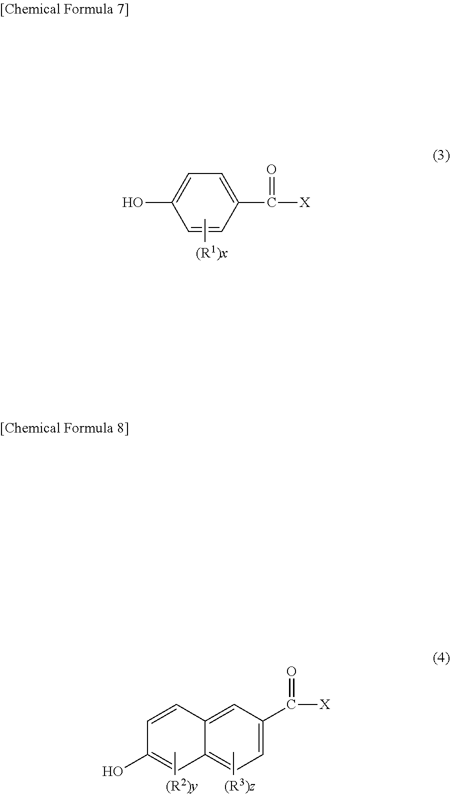

Compounds represented by general formulae (3) and (4) are compounds represented by general formulae (I) and (II) in which R⁴ represents a hydrogen atom, respectively.

As an example of a “reaction to increase the reactivity of the phenolic hydroxyl group”, an acylation reaction in which the phenolic hydroxy group is reacted with a carboxylic acid or acetic anhydride can be mentioned. In terms of availability of reagents and high reactivity, an acylation reaction in which the phenolic hydroxy group is reacted with acetic anhydride is preferable. The acylation reaction may be performed in a reaction vessel separate from the reaction vessel for performing the polycondensation reaction. However, in terms of simplifying the operation, it is preferable to perform the acylation reaction in the same reaction vessel as that in which the polycondensation reaction is performed, and then in situ perform the polycondensation reaction.

In such acylation reaction, it is preferable to react an anhydride such as acetic anhydride in an amount of 1 equivalent to 1.3 equivalents, more preferably 1.05 equivalents to 1.15 equivalents, based on the phenolic hydroxyl group within the compound represented by general formula (I) or (II).

In the acylation reaction, a reaction vessel made of a corrosion-proof material such as titanium or Hastelloy B can be used. Further, in the case where the objective liquid crystal polyester requires a bright color tone (high L value), it is preferable that the material of the inner wall of the reaction vessel is made of glass. As long as the inner wall which comes into contact with the reaction mixture is made of glass, the entire reaction vessel does not need to be made of glass. For example, a reaction vessel made of SUS which has been subjected to glass lining can be used. For example, in a large scale production facility, it is preferable to use a reaction vessel which has been subjected to glass lining.

In the present step, the polycondensation reaction is performed until the initial flow temperature of the obtained prepolymer becomes 210° C. to 240° C.

When the initial flow temperature is lower than 210° C., in the solid-phase polymerization described later, adhesion of the liquid crystal polyester is likely to occur, and by-products are likely to be formed in large amounts, such that the polymerization reaction is difficult to proceed, and also becomes economically disadvantageous. On the other hand, when the initial flow temperature is higher than 240° C., the viscosity of the prepolymer becomes high, such that it becomes difficult to discharge the prepolymer from the reaction vessel. Further, stirring and mixing during the reaction becomes difficult, such that the heating becomes non-uniform, thereby adversely affecting the thermal stability of the obtained liquid crystal polyester.

The polycondensation is performed as described above, thereby obtaining a prepolymer.

(Pulverizing Step)

In the pulverizing step, the prepolymer obtained by the above polycondensation reaction is discharged and collected from the reaction vessel in a molten state.

When the prepolymer is taken out in a molten state, in terms of preventing deterioration of the color of the obtained liquid crystal polyester, it is preferable to take out the prepolymer in an inert gas atmosphere such as a nitrogen atmosphere. However, when the water content is small, the prepolymer may be taken out in air. Further, when the prepolymer is taken out in a molten state, it is preferable to pressurize the reaction vessel with an inert gas such as a nitrogen gas to a gauze pressure of 0.1 kg/cm²G to 2 kg/cm²G, more preferably 0.2 kg/cm²G to 1 kg/cm²G (provided that atmospheric pressure=1.033 kg/cm²A). By pressurizing the reaction vessel for purging, generation of by-products can be suppressed, and the equilibrium of the polycondensation reaction is not biased to the production of polymer. As a result, increase in the molecular weight of the prepolymer can be suppressed, and hence, rise in the initial flow temperature of the polymer at the time of taking out the prepolymer can be suppressed.

Examples of the facility for collecting the prepolymer include conventional extruders and gear pumps, although only a mere valve may be used. When the prepolymer that has been polymerized to the above initial flow temperature is taken out and cooled, the prepolymer is solidified. Thus, depending on the object, the prepolymer can be cut by a strand cutter or a sheet cutter, or pulverized. As an example of a method of treating in a short time in large amounts, there can be mentioned a method described in Japanese Unexamined Patent Application, First Publication No. Hei 6-256485 in which the prepolymer is fed to a weight/volume/counting feeder and then cooled by a double belt cooler.

Further, as a method of washing the reaction vessel after collecting the prepolymer, a method described in Japanese Unexamined Patent Application, First Publication No. Hei 5-29592 and Japanese Unexamined Patent Application, First Publication No. Hei 5-29593 in which either or both of a glycol and an amine is used can be mentioned.

The prepolymer powder obtained in the pulverizing step is particles (powder) having a particle diameter of 3 mm or less, preferably 0.5 mm or less, and more preferably 0.1 mm to 0.4 mm. When the particle diameter exceeds 3 mm, due to the difference between the surface layer of the particles and the inner portion of the particles in terms of the polymerization rate and the diffusion time of the by-products generated as a result of the reaction of unreacted raw materials, disadvantages are likely to be caused in that the molecular weight distribution becomes large, and foaming and generation of gas is likely to occur because volatile components are not sufficiently removed.

Here, a “particle diameter of 3 mm or less” refers to a size which can pass through a sieve with an aperture of 3 mm.

In the manner as described above, a prepolymer powder can be obtained.

(Solid-Phase Polymerization Step)

In the solid-phase polymerization step, the prepolymer powder is subjected to a heat treatment in a solid-phase state in an inert gas atmosphere, so as to perform a solid-phase polymerization to obtain an objective liquid crystal polyester. In this manner, unreacted raw materials can be removed, and the molecular weight can be increased, thereby improving the properties of the liquid crystal polyester.

In the present embodiment, it has been found that, by controlling the rate of temperature rise for reaching the final end-point temperature of the solid-phase polymerization in the solid-phase polymerization step to be within a predetermined range, sintering can be suppressed.

Specifically, in the solid-phase polymerization step, during the temperature rise, a rate of temperature rise within a temperature range of from a temperature 10° C. lower than a final end-point temperature of the solid-phase polymerization (final end-point temperature −10° C.) to the final end-point temperature is from 0.01° C./min to 0.03° C./min. By virtue of such rate of temperature rise, the liquid crystal polyester obtained by the solid-phase polymerization can be suppressed from sintering, so that a liquid crystal polyester powder having a desired particle size can be reliably obtained.

The final end-point temperature of the solid-phase polymerization is determined depending on the initial flow temperature of the objective liquid crystal polyester. Specifically, the final end-point temperature can be confirmed by conducting a preparatory experiment in which a solid-phase polymerization of the prepolymer is actually performed with a plurality of levels of final end-point temperatures, based on the initial flow temperature of the prepolymer used in the solid-phase polymerization and the initial flow temperature of the objective liquid crystal polyester.

Sintering occurs when, after the surface of the prepolymer powder is melted by heating, the prepolymer is cooled and the close prepolymer powders adhere to each other. On the other hand, in a solid-phase polymerization step, as the polymerization of the prepolymer proceeds by heating, the initial flow temperature of the prepolymer rises, so that the temperature at which sintering occurs (i.e., the temperature at which the surface of the powder melts) becomes higher as the solid-phase polymerization proceeds. However, when the rate of temperature rise during the solid-phase polymerization is high, the temperature during the solid-phase polymerization exceeds the initial flow temperature of the prepolymer, such that the surface of the powder is likely to start melting.

The present inventors have empirically confirmed that, in particular, when the rate of temperature rise is high within a temperature range of from a temperature 10° C. lower than a final end-point temperature of the solid-phase polymerization (final end-point temperature −10° C.) to the final end-point temperature, sintering is likely to occur.

Thus, in the present embodiment, the rate of temperature rise within a temperature range of from a temperature 10° C. lower than a final end-point temperature of the solid-phase polymerization (final end-point temperature −10° C.) to the final end-point temperature is from 0.01° C./min to 0.03° C./min. Therefore, solid-phase polymerization can be performed while suppressing sintering.

In the present embodiment, the final end-point temperature of the solid-phase polymerization is preferably from 200° C. to 255° C., and more preferably from 230° C. to 250° C.

As the apparatus for conducting the solid-phase polymerization, various apparatuses conventionally known can be used which is capable of subjecting the powder to heat treatment, such as a dryer, a mixer or an electric furnace. However, since the solid-phase polymerization is performed in an inert gas atmosphere, it is preferable to use a highly hermetic, gas flow-type apparatus.

The inert gas is preferably selected from the group consisting of nitrogen, helium, argon and carbon dioxide gas, and more preferably nitrogen. The flow rate of the inert gas is determined, taking into consideration of the volume of the solid-phase polymerization apparatus, the particle diameter of the powder, the packing state and the like. However, the flow rate per 1 m³ of the reaction vessel is preferably 2 m³/hr to 8 m³/hr, and more preferably 3 m³/hr to 6 m³/hr. When the flow rate of the inert gas is less than 2 m³/hr, the polymerization rate is low, and when the flow rate of the inert gas exceeds 8 m³/hr, scattering of the powder is likely to occur, which is unfavorable.

In the manner as described above, an objective liquid crystal polyester can be obtained.

The liquid crystal polyester obtained by the production method according to the present embodiment preferably contains a repeating unit represented by general formula (1) shown below in an amount of 20 mol % to 80 mol %, based on the total amount of all repeating units, and a repeating unit represented by general formula (2) shown below in an amount of 20 mol % to 80 mol %, based on the total amount of all repeating units.

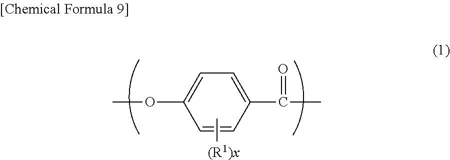

wherein R¹ represents a chlorine atom, a bromine atom or an alkyl group of 1 to 4 carbon atoms; and x represents an integer of 0 to 4, provided that, when x represents an integer of 2 or more, the plurality of R¹ may be the same or different from each other; and the repeating unit represented by general formula (1) may comprise a plurality of repeating units in which at least one R¹ is different from other R¹.

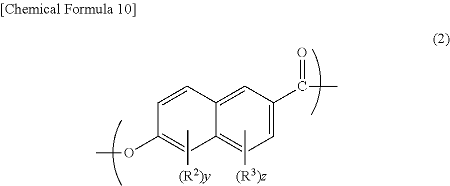

wherein R² and R³ each independently represent a chlorine atom, a bromine atom or an alkyl group of 1 to 4 carbon atoms; y represents an integer of 0 to 3; and z represents an integer of 0 to 3, provided that R² and R³ may be the same or different from each other, and the repeating unit represented by general formula (2) may comprise a plurality of repeating units in which at least one of R² and R³ is different from other R² and R³.

The initial flow temperature of the liquid crystal polyester is preferably 210° C. to 320° C., more preferably 220° C. to 300° C., and further preferably 230° C. to 280° C. When the initial flow temperature exceeds 320° C., it is considered that the processing temperature exceeds 350° C., and thermal decomposition of the liquid crystal polyester becomes active, which is unfavorable.

Further, in the method of producing a liquid crystal polyester according to the present embodiment, the liquid crystal polyester obtained by the above method can be melted and granulated. The shape of the grains is preferably in the form of pellets.

As an example of the method of granulating the liquid crystal polyester powder to produce pellets, there can be mentioned a method in which a typical single-screw or twin-screw extruder is used to conduct melt-kneading, followed by air cooling or water cooling if desired, and molding by a pelletizer (strand cutter) to form pellets. In terms of homogenization by melting and molding, a general extruder can be used. From the viewpoint of homogenization by melting, it is preferable to use an extruder having a large effective length of screw (L/D, wherein L is the screw length, and D is the screw diameter). In the melt kneading, the cylinder temperature (die head temperature) of the extruder is preferably in the range of 200° C. to 350° C., more preferably 230° C. to 330° C., and further preferably 240° C. to 320° C.

The method of obtaining the liquid crystal polyester in the form of pellets is not limited to the above method. For example, in the “pulverizing step”, the prepolymer in a molten state may be discharged onto a parallel roller having grooves, so as to mold the prepolymer into strands. Then, the stands may be cut into pellets having a particle diameter of no more than 3 mm, followed by heating the pellets, thereby obtaining a liquid crystal polyester in the form of pellets.

If desired, the liquid crystal polyester produced by the production method of the present embodiment may have an organic filler added thereto, as long as the effects of the present invention are not impaired. Examples of the organic filler include calcium carbonate, talc, clay, silica, magnesium carbonate, barium sulfate, titanium oxide, alumina, montmorillonite, gypsum, glass flake, glass fibers, carbon fibers, alumina fibers, silica alumina fibers, aluminum borate whisker and potassium titanate fibers. These organic fillers can be used as long as the essential properties (transparency, mechanical strength, and the like) of the molded article obtained by using a liquid crystal polyester produced by the production method according to the present embodiment are not markedly deteriorated.

Furthermore, in the liquid crystal polyester produced by the production method of the present embodiment, various additives such as organic fillers, antioxidants, heat stabilizers, light stabilizers, flame retardants, lubricants, antistatic agents, inorganic or organic colorants, rust inhibitors, crosslinking agents, foaming agents, fluorescent agents, surface smoothing agents, surface gloss modifiers, mold release agent such as fluorine resins can be added.

The method of producing a liquid crystal polyester as described above is capable of suppressing sintering of the powder after the solid-phase polymerization, and hence, it becomes possible to stably produce a liquid crystal polyester in a continuous manner.

While an example of a preferred embodiment of the present invention has been described above with reference to the attached figures, it should be noted that these are exemplary of the invention and are not to be considered as limiting the present invention. Additions, omissions, substitutions, and other modifications can be made without departing from the scope of the present invention.

### EXAMPLES

As follows is a description of examples of the present invention, although the scope of the present invention is by no way limited by these examples.

[Initial Flow Temperature]

The flow temperature was measured by melting a liquid crystal polyester under a load of 9.8 MPa (100 kg/cm²) while raising the temperature at a rate of 4° C./min, and the temperature at which the liquid crystal polyester exhibits a viscosity of 4,800 Pa·S (48,000 poise) as measured using a capillary rheometer equipped with a dice having an inner diameter of 1 mm and a length of 10 mm when extruded from the nozzle was defined as the flow temperature. The initial flow temperature can be measured by a flow property evaluation apparatus “Flow Tester CFT-500D” (manufactured by Shimadzu Corporation). The flow temperature was used as a yardstick for the molecular weight of a liquid crystal polyester (see “Liquid crystal polymer—synthesis, molding and application—” written by Naoyuki Koide, published by CMC Publishing CO., LTD, Jun. 5, 1987; see pages 95-105).

[Evaluation of Sintering]

The powder after solid-phase polymerization and cooling was placed in a plastic bag, and a sensory evaluation was conducted to check whether or not the powder could be loosened by hand. If sintering of the powder had occurred after the solid-phase polymerization, the powder cannot be loosened by hand, and a bulky state is maintained.

### Example 1

### (1) Melt Polymerization

A 3-L four-necked separable flask having a Dimroth condenser, a three-way connecting tube equipped with a nitrogen feeding pipe and a thermocouple for measuring the internal temperature, and an anchor-shaped agitator, as well as a thermocouple on the outside of the flask was used as a polymerization vessel. 1,176.8 g (8.52 mol) of 4-hydroxybenzoic acid, 654.9 g (3.48 mol) of 6-hydroxy-2-naphthoic acid and 1,347.6 g (13.2 mol) of acetic anhydride were charged into the polymerization vessel, and the outer temperature of the flask was raised to 150° C. using a mantle heater while flowing nitrogen. Then, an acetylation reaction was performed for approximately 3 hours under reflux while stirring at 200 rpm. After the completion of the acetylation reaction, the temperature was risen to 280° C. at a rate of 0.6° C./min. During this time, acetic acid by-produced in the polycondensation reaction was continuously removed by distillation. After reaching a temperature of 280° C., the temperature was maintained for 50 minutes, then, the stirring was stopped and the polymer was taken out in a molten state. After a while, the obtained polyester (prepolymer) was solidified.

The obtained prepolymer was roughly pulverized into plates having a thickness of 1 to 2 mm, and then pulverized using a pulverizer (VM-16; manufactured by ORIENT Co., Ltd.), thereby obtaining a prepolymer powder (prepolymer powder 1). The initial flow temperature of prepolymer powder 1 was measured, and was found to be 232° C.

### (2) Solid-Phase Polymerization

The obtained prepolymer powder 1 was packed in a metal tray and placed in an electric furnace, followed by rising the temperature from room temperature to 225° C. at a rate of 3.6° C./min in a nitrogen atmosphere. Then, the temperature was risen to 235° C. at a rate of 1.0° C./min, followed by rising the temperature to 245° C. at a rate of 0.02° C./min and maintaining that temperature for 5 hours. Thereafter, the electric furnace was cooled, and the polymer was taken out, thereby obtaining a liquid crystal polyester 1 having an initial flow temperature of 271° C.

### Example 2

Prepolymer powder 2 was obtained in the same manner as in Example 1, except that, in the melt polymerization, the retention time at a temperature of 280° C. was changed to 40 minutes. The initial flow temperature of prepolymer powder 2 was measured, and was found to be 228° C.

The obtained prepolymer powder 2 was subjected to solid-phase polymerization in the same manner as in Example 1, thereby obtaining a liquid crystal polyester 2 having an initial flow temperature of 269° C.

### Comparative Example 1

Melt polymerization was conducted in the same manner as in Example 1, thereby obtaining a prepolymer 3. The initial flow temperature of prepolymer powder 3 was measured, and was found to be 232° C.

The obtained prepolymer powder 3 was packed in a metal tray and placed in an electric furnace, followed by rising the temperature from room temperature to 190° C. at a rate of 3.6° C./min in a nitrogen atmosphere. Then, the temperature was risen to 200° C. at a rate of 1.0° C./min, followed by rising the temperature to 247° C. at a rate of 0.13° C./min and maintaining that temperature for 5 hours. Thereafter, the electric furnace was cooled, and the polymer was taken out, thereby obtaining a liquid crystal polyester 3 having an initial flow temperature of 271° C.

### Comparative Example 2

Prepolymer powder 4 was obtained in the same manner as in Example 1, except that, in the melt polymerization, the retention time at a temperature of 280° C. was changed to 10 minutes. The initial flow temperature of prepolymer powder 4 was measured, and was found to be 209° C.

The obtained prepolymer powder 4 was packed in a metal tray and placed in an electric furnace, followed by rising the temperature from room temperature to 180° C. at a rate of 0.83° C./min in a nitrogen atmosphere, followed by maintaining that temperature for 2 hours. Then, the temperature was risen to 265° C. at a rate of 0.2° C./min, followed by maintaining that temperature for 5 hours. Thereafter, the electric furnace was cooled, and the polymer was taken out, thereby obtaining a liquid crystal polyester 4 having an initial flow temperature of 278° C.

### Comparative Example 3

Prepolymer powder 5 was obtained in the same manlier as in Example 1, except that, in the melt polymerization, the retention time at a temperature of 280° C. was changed to 60 minutes. The initial flow temperature of prepolymer powder 5 was measured, and was found to be 235° C.

The obtained prepolymer powder 5 was packed in a metal tray and placed in an electric furnace, followed by rising the temperature from room temperature to 225° C. at a rate of 3.6° C./min in a nitrogen atmosphere. Then, the temperature was risen to 235° C. at a rate of 1.0° C./min, followed by rising the temperature to 245° C. at a rate of 0.04° C./min and maintaining that temperature for 5 hours. Thereafter, the electric furnace was cooled, and the polymer was taken out, thereby obtaining a liquid crystal polyester 5 having an initial flow temperature of 270° C.

### Comparative Example 4

Melt polymerization was conducted in the same manner as in Example 1, thereby obtaining a prepolymer 6. The initial flow temperature of prepolymer powder 6 was measured, and was found to be 233° C.

The obtained prepolymer powder 6 was packed in a metal tray and placed in an electric furnace, followed by rising the temperature from room temperature to 160° C. at a rate of 3.6° C./min in a nitrogen atmosphere. Then, the temperature was risen to 225° C. at a rate of 1.0° C./min, followed by rising the temperature to 248° C. at a rate of 0.065° C./min and maintaining that temperature for 5 hours. Thereafter, the electric furnace was cooled, and the polymer was taken out, thereby obtaining a liquid crystal polyester 6 having an initial flow temperature of 269° C.

The results of the evaluation of sintering with respect to Examples 1 and 2 and Comparative Examples 1 to 4 are shown below in Table 1.

TABLE 1

| | | | Comp. | Comp. | Comp. | Comp. |
|---|---|---|---|---|---|---|
| | Ex. 1 | Ex. 2 | Ex. 1 | Ex. 2 | Ex. 3 | Ex. 4 |
| Initial flow temperature of prepolymer | 232 | 228 | 232 | 209 | 235 | 233 |
| (° C.) | | | | | | |
| Final end-point temperature (° C.) | 245 | | 247 | 265 | 245 | 248 |
| Rate of temperature rise from final end- | 0.02 | | 0.13 | 0.2 | 0.04 | 0.065 |
| point temperature - 10° C. to final end- | | | | | | |
| point temperature (° C./min) | | | | | | |
| Initial flow temperature of liquid crystal | 271 | 269 | 271 | 278 | 270 | 269 |
| polyester (° C.) | | | | | | |

| | | |
|---|---|---|
| Occurrence of sintering | None | Confirmed |

As a result of the measurements, it was confirmed that, in Comparative Examples 1 to 4 in which the rate of temperature rise exceeds 0.03° C./min in a temperature range of from a temperature 10° C. lower than a final end-point temperature of the solid-phase polymerization to the final end-point temperature, sintering had occurred. On the other hand, in Examples 1 and 2 in which the rate of temperature rise was 0.02° C./min, a powder could be retained by loosening by hand after the solid-phase polymerization, meaning that no sintering occurred.

From these results, the usefulness of the present invention was confirmed.

1. A method of producing a liquid crystal polyester, comprising:
preparing a liquid crystal polyester prepolymer comprising a repeating unit represented by general formula (1) shown below and a repeating unit represented by general formula (2) shown below by melt polymerization,
cooling and solidifying the prepolymer to obtain a solidified prepolymer,
pulverizing the solidified prepolymer to obtain a prepolymer powder, and
heating the prepolymer powder to conduct solid-phase polymerization, thereby preparing a liquid crystal polyester having a polymerization degree higher than the prepolymer,
wherein preparing a liquid crystal polyester is performed with a rate of temperature rise within a temperature range of from a temperature 10° C. lower than a final end-point temperature of the solid-phase polymerization to the final end-point temperature of from 0.01° C./min to 0.03° C./min: 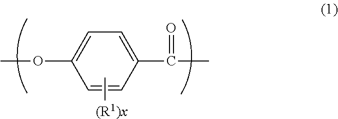
wherein R¹ represents a chlorine atom, a bromine atom or an alkyl group of 1 to 4 carbon atoms; and x represents an integer of 0 to 4, provided that, when x represents an integer of 2 or more, the plurality of R¹ may be the same or different from each other; and the repeating unit represented by general formula (1) may comprise a plurality of repeating units in which at least one R¹ is different from other R¹; and 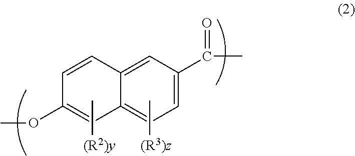
wherein R² and R³ each independently represent a chlorine atom, a bromine atom or an alkyl group of 1 to 4 carbon atoms; y represents an integer of 0 to 3; and z represents an integer of 0 to 3, provided that R² and R³ may be the same or different from each other, and the repeating unit represented by general formula (2) may comprise a plurality of repeating units in which at least one of R² and R³ is different from other R² and R³.

2. The method according to claim 1, wherein the amount of the repeating unit represented by general formula (1) is from 20 mol % to 80 mol %, based on the total amount of all repeating units, and the amount of the repeating unit represented by general formula (2) is from 20 mol % to 80 mol %, based on the total amount of all repeating units.

3. The method according to claim 1, wherein the final end-point temperature is 200° C. to 255° C.

4. The method according to claim 2, wherein the final end-point temperature is 200° C. to 255° C.
